(19) United States
(12) Patent Application Publication
(10) Pub. No.: US 2014/0125994 A1
(43) Pub. Date: May 8, 2014

(54) MOTION SENSOR ARRAY DEVICE AND DEPTH SENSING SYSTEM AND METHODS OF USING THE SAME

(71) Applicants: Tae Chan KIM, Yongin-si (KR); Moo Young KIM, Suwon-si (KR)

(72) Inventors: Tae Chan KIM, Yongin-si (KR); Moo Young KIM, Suwon-si (KR)

(21) Appl. No.: 14/067,093

(22) Filed: Oct. 30, 2013

(30) Foreign Application Priority Data
Nov. 2, 2012 (KR) 10-2012-0123524

(51) Int. Cl. G01B 11/22; G01B 11/24

(52) U.S. Cl. CPC G01B 11/22; G01B 11/24
USPC 356/601; 250/206.1

(57) ABSTRACT

In one example of the inventive concepts, a motion sensor array device includes a wafer and at least two motion sensors implemented on the wafer, each of the at least two motion sensors including a plurality of motion sensor pixels to sense a motion of an object and generate motion image data. The motion sensor array device further includes at least two lenses respectively arranged on the at least two motion sensors, wherein the motion sensor array is implemented in one of a chip and a package.

### CROSS-REFERENCE TO RELATED APPLICATIONS

This application claims priority under 35 U.S.C. §119(a) from Korean Patent Application No. 10-2012-0123524 filed on Nov. 2, 2012, the disclosure of which is hereby incorporated by reference in its entirety.

### BACKGROUND

Embodiments of the inventive concepts relate to a motion sensor and/or systems using the same, for obtaining depth information from at least two motion sensors.

Minimizing power consumption in portable devices such as smart phones and digital cameras, is an ever-present challenge to manufacturers of such portable devices. Meanwhile, depth sensors embedded within the image capturing elements of such devices for capturing depth information of images, usually require a light source. Such light sources have high power consumption.

### SUMMARY

Some example embodiments provide apparatuses, systems and/or methods for capturing images including depth information of such images with lower power consumption.

In one example of the inventive concepts, a motion sensor array device includes a wafer and at least two motion sensors implemented on the wafer, each of the at least two motion sensors including a plurality of motion sensor pixels to sense a motion of an object and generate motion image data. The motion sensor array device further includes at least two lenses respectively arranged on the at least two motion sensors, wherein the motion sensor array is implemented in one of a chip and a package.

In yet another example embodiment, the motion sensor array device further includes a depth sensor configured to extract depth information regarding the object from the motion image data respectively generated by the at least two motion sensors.

In yet another example embodiment, the motion sensor array device further includes a three-dimensional image generator configured to generate a three-dimensional image by combining the depth information and the motion image data.

In yet another example embodiment, the at least two lenses are wafer lenses and the motion sensor array device is implemented in the package.

In yet another example embodiment, each of the motion sensor pixels is a dynamic vision sensor (DVS) pixel.

In yet another example embodiment of the inventive concepts, each of the at least two motion sensors includes a pixel array comprising a plurality of DVS pixels and a row address event representation (AER) circuit configured to process at least a first event signal among a plurality of event signals generated by each of the DVS pixels. Each of the at least two motion sensors further includes a column AER circuit configured to process at least a second event signal among the plurality of event signals generated by each DVS pixel.

In yet another example embodiment, a depth sensing system comprises, the motion sensor array device described above, an image signal processor configured to process image data output from the motion sensor array device, and a central processing unit configured to control the motion sensor array device and the image signal processor.

In one example embodiment, a depth sensing system includes a motion sensor array comprising at least two motion sensors each of which comprises a plurality of motion sensor pixels configured to sense a motion of an object and generate motion image data. The depth sensing system further includes a depth sensor configured to extract depth information regarding the object from the motion image data respectively generated by the at least two motion sensors.

In yet another example embodiment, the at least two motion sensors include a first motion sensor configured to sense the motion of the object at a first position and generate first motion image data. The at least two motion sensors further includes a second motion sensor configured to sense the motion of the object at a second position and generate second motion image data

In yet another example embodiment, the depth sensor generates the depth information based on disparity between the first motion image data and the second motion image data.

In yet another example embodiment, the at least two motion sensors are M×N motion sensors arranged in a matrix form, where at least one of M and N is a natural number having a value of at least 2.

In yet another example embodiment, the depth sensor generates the depth information based on disparity among motion image data respectively generated by the M×N motion sensors.

In yet another example embodiment, the depth sensor generates the depth information based on disparity among motion image data generated by the M×N motion sensors.

In yet another example embodiment, the motion sensor array is implemented in one of a chip and a package.

In yet another example embodiment, the motion sensor array and the depth sensor are implemented together in one of a chip and a package.

In yet another example embodiment, the depth sensing system further includes a three-dimensional image generator configured to generate a three-dimensional image by combining the depth information and the motion image data.

In yet another example embodiment, the depth sensing system further includes at least one lens stacked on each of the at least two motion sensors.

In one example embodiment of the inventive concepts, a depth sensing method using a motion sensor array includes generating motion image data by sensing a motion of an object using at least two motion sensors each of which includes a plurality of motion sensor pixels and generating depth information regarding the object from the motion image data generated by the at least two motion sensors.

In yet another example embodiment, the generating the motion image data includes detecting a change in an intensity of light incident on one of the plurality of motion sensor pixels and generating an event signal based on the detected change. The method further includes outputting address information of a motion sensor pixel that has generated the event signal, and generating the motion image data based on the address information.

In yet another example embodiment, the generating the depth information includes generating the depth information based on disparity between the motion image data respectively generated by the at least two motion sensors.

In yet another example embodiment, the method further includes generating a three-dimensional image by combining the depth information and the motion image data.

In one example embodiment, a depth sensing system includes a motion sensor array configured to sense motion of at least one object at a plurality of positions and generate a plurality of motion image data based on the motion sensed at the plurality of positions. The depth sensing system further includes an image processor configured to determine depth information of the object based on the plurality of generated motion image data.

In yet another example embodiment, the motion sensor array is configured to sense the motion at each of the plurality of positions based on at least one of shade information of a frame captured in each of the plurality of positions and at least one stored shade information, and voltage value of the captured frame and at least one stored voltage value.

In yet another example embodiment, the image processor is configured to determine the depth information based on disparity between at least two of the plurality of generated motion image data.

In yet another example embodiment, the depth sensing system further includes a three-dimensional image generator configured to generate a three-dimensional image by combining the depth information and the plurality of generated motion image data.

In yet another example embodiment, the motion sensor array includes a plurality of motion sensors, each of the plurality of motion sensors sensing the motion at one of the plurality of positions.

### BRIEF DESCRIPTION OF THE DRAWINGS

The above and other features and advantages of the inventive concepts will become more apparent by describing in detail exemplary embodiments thereof with reference to the attached drawings in which:

FIG. 1 is a block diagram of a depth sensing system using a motion sensor array, according to an example embodiment of the inventive concepts;

FIG. 2 is a block diagram of a motion sensor array illustrated in FIG. 1, according to an example embodiment of the inventive concepts;

FIG. 3 is a block diagram of a motion sensor illustrated in FIG. 2, according to an example embodiment of the inventive concepts;

FIG. 4 is a block diagram of an image signal processor (ISP) illustrated in FIG. 1, according to an example embodiment of the inventive concepts;

FIG. 5 is a diagram of wiring of the motion sensor illustrated in FIG. 3, according to an example embodiment of the inventive concepts;

FIG. 6 is a diagram of a motion sensor pixel illustrated in FIG. 5, according to an example embodiment of the inventive concepts;

FIG. 7 is a block diagram of a depth sensing system using a motion sensor array, according to an example embodiment of the inventive concepts;

FIG. 8A is a block diagram of a motion sensor, according to an example embodiment of the inventive concepts;

FIG. 8B is a block diagram of an ISP, according to an example embodiment of the inventive concepts;

FIG. 9A is a diagram of motion data output from the motion sensor array, according to an example embodiment of the inventive concepts;

FIG. 9B is a diagram of motion data output from the motion sensor array, according to an example embodiment of the inventive concepts;

FIG. 10 is a diagram of a motion sensor array device implemented, according to an example embodiment of the inventive concepts;

FIG. 11 is a block diagram of an electronic system including the motion sensor array illustrated in FIG. 1, according to an example embodiment of the inventive concepts; and

FIG. 12 is a block diagram of an image processing system including the motion sensor array illustrated in FIG. 1, according to an example embodiment of the inventive concepts.

### DETAILED DESCRIPTION OF THE EMBODIMENTS

The inventive concepts now will be described more fully hereinafter with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,' or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

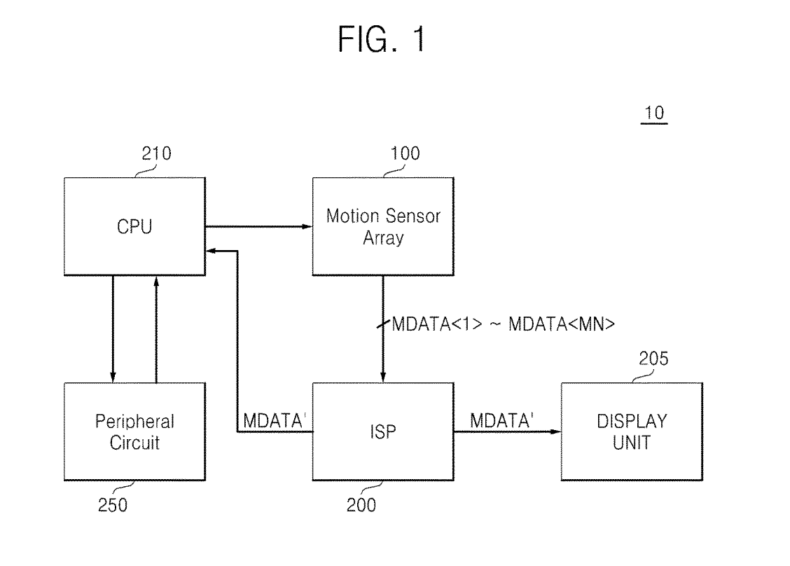

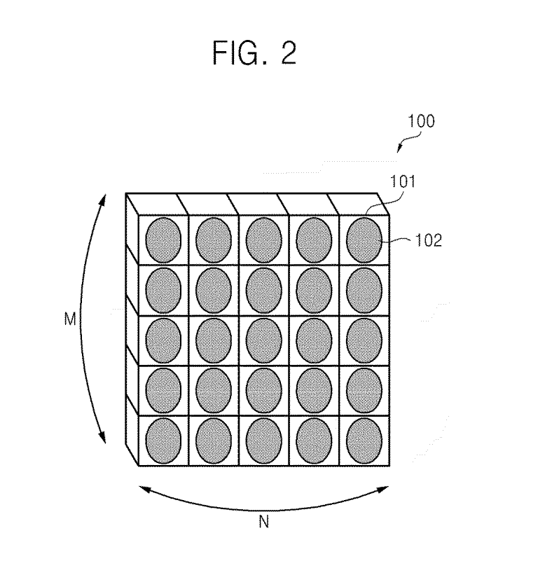

FIG. 1 is a block diagram of a depth sensing system 10, according to an example embodiment of the inventive concepts. FIG. 2 is a block diagram of a motion sensor array 100 illustrated in FIG. 1, according to an example embodiment of the inventive concepts.

Referring to FIGS. 1 and 2, the depth sensing system 10 may include the motion sensor array 100, an image signal processor (ISP) 200, a display unit 205, a central processing unit (CPU) 210, and a peripheral circuit 250. In one example embodiment, the depth sensing system 10 may be implemented in a form of system on chip (SoC).

The depth sensing system 10 may include a plurality of motion sensors that sense a motion of an object and acquire motion image data so as to obtain depth information. As shown in FIG. 2, a plurality of motion sensors 101 may be arranged in an M×N array where M and N are 1 or a natural number greater than 1 and M and/or N are integers equal to or greater than 2.

The motion sensor array 100 may include a plurality of the motion sensors 101 and a lens 102 provided on each of the motion sensors 101. Each of the motion sensors 101 senses a motion of an object from their positions and generates motion image data or an event signal (e.g., motion address information) for generating the motion image data. Accordingly, motion image data picked up at many different angles can be obtained using the motion sensors 101 arranged in the M×N array.

Each motion sensor 101 may analyze images consecutively captured by frames and may store shade information of each analyzed frame in a digital code in a frame memory (not shown). The motion sensor 101 may compare shade information of a previous frame that has been stored in the frame memory with shade information of a current frame that has been newly received and sense the motion of an object. When acquiring shade information of a single pixel, the motion sensor 101 may also process shade information of adjacent pixels (e.g., four adjacent pixels above, below, on the right, and on the left of the single pixel, respectively) together so as to calculate the moving direction of the shade.

Alternatively, the motion sensor 101 may include a signal storage device (e.g., a capacitor) in a pixel. The motion sensor 101 may store a voltage value corresponding to a pixel signal of a previous frame and compare the voltage value with a voltage value corresponding to a pixel signal of a current frame so as to sense the motion of an object.

As described above, the motion sensor 101 senses the motion of an object using various methods to generate motion image data MDATA. Accordingly, the motion sensor array 100 including the plurality of the motion sensors 101 may generate motion image data MDATA<1> through MDATA<MN> captured at different angles and transmit the motion image data MDATA<1> through MDATA<MN> to the ISP 200. In one example embodiment, MDATA<1>denotes motion image data that is captured by a (1,1) motion sensor 101 among the M×N motion sensors 101 and MDATA<MN> denotes motion image data that is captured by a (M,N) motion sensor 101 among the M×N motion sensors 101.

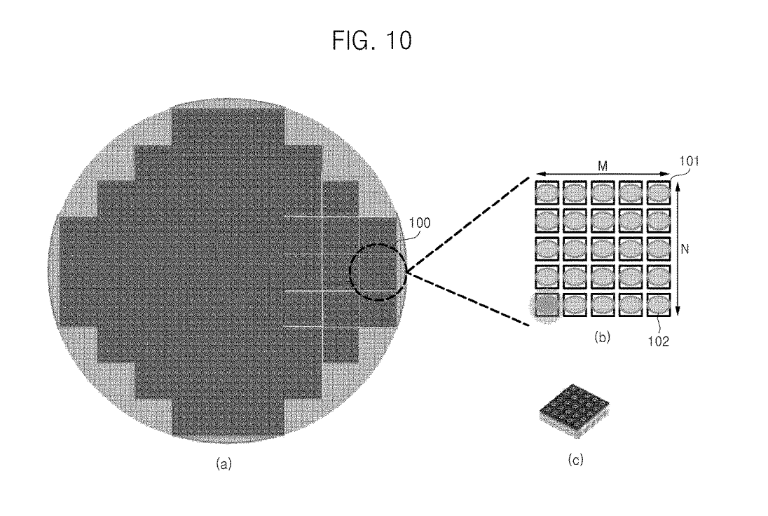

The motion sensor array 100 may be implemented on a single wafer and may be implemented as a single package module. This will be described in detail below, with reference to FIG. 10.

The ISP 200 may receive the motion image data MDATA<1> through MDATA<MN> from the motion sensor array 100, process the motion image data MDATA<1> through MDATA<MN>, and generate processed motion image data MDATA′. The ISP 200 may make the motion image data MDATA<1> through MDATA<MN> into a frame. The ISP 200 may also correct brightness, contrast, and chroma associated with the motion image data MDATA<1> through MDATA<MN>.

The ISP 200 may also generate depth information from the motion image data MDATA<1> through MDATA<MN> and may embed the depth information in the processed motion image data MDATA′. The ISP 200 may also generate three-dimensional image data by combining the depth information with the processed motion image data MDATA′. The ISP 200 may transmit the processed motion image data MDATA′ to the display unit 205 and the CPU 210. The ISP 200 may control the overall operation of the motion sensor array 100.

Although the ISP 200 is implemented outside the motion sensor array 100 in the example embodiments, the inventive concepts are not restricted to the example embodiments. For instance, the ISP 200 may be implemented inside the motion sensor array 100.

The display unit 205 may display the processed motion image data MDATA′. The display unit 205 may be any device that can output an image. For instance, the display unit 205 may be implemented as an electronic device including, but not limited to,a computer, a mobile phone, and a camera.

The CPU 210 may control the motion sensor array 100 based on a signal (or data) received from the peripheral circuit 250. The peripheral circuit 250 may provide the CPU 210 with signals (or data) generated according to system states and/or various inputs. The various inputs may be signals input through an input/output (I/O) interface.

The peripheral circuit 250 may be implemented as the input/output (I/O) interface. Accordingly, the peripheral circuit 250 may transmit a signal generated by a user's input to the CPU 210. The I/O interface may be any type of I/O device including, but not limited to, an external input button, a touch screen, or a mouse.

Alternatively, the peripheral circuit 250 may be implemented as a power monitoring module. Accordingly, when it is determined that system power supply is insufficient, the peripheral circuit 250 may transmit a signal corresponding to the determination to the CPU 210. The CPU 210 may disable or limit the capability of at least one of the motion sensor array 100 and the display unit 205.

As another alternative, the peripheral circuit 250 may be implemented as an application execution module. Accordingly, when a particular application is executed, the peripheral circuit 250 may transmit a signal generated from the application execution module to the CPU 210. The particular application may be any one of, but not limited to, a camera shooting application, an augmented reality application, or any application requiring a camera image.

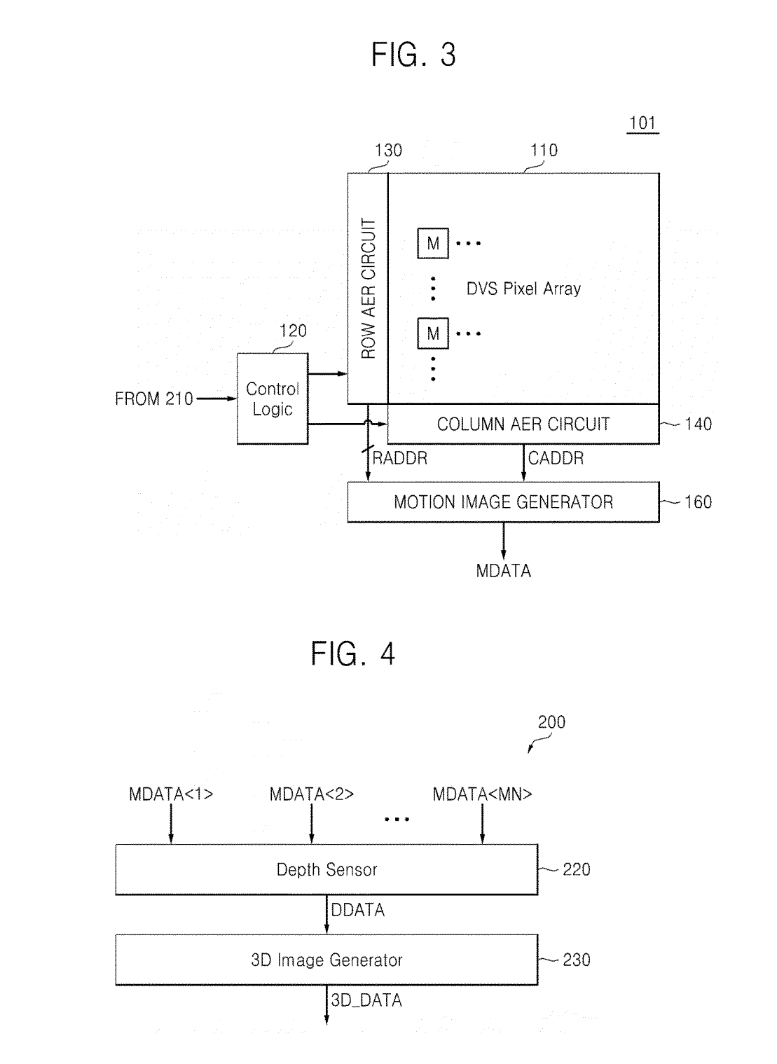

FIG. 3 is a block diagram of each of the motion sensors 101 illustrated in FIG. 2, according to an example embodiment of the inventive concepts. Referring to FIG. 3, the motion sensor 101 may include a pixel array 110, a control logic or control circuit 120, an address event representation (AER) unit, and a motion image generator 160. The AER unit may include a row AER circuit 130 and a column AER circuit 140.The pixel array 110 may include a plurality of motion sensor pixels M sensing the motion of an object. The motion sensor pixels M may be implemented by dynamic vision sensor (DVS) pixels in the example embodiments, but the inventive concepts are not restricted to the current embodiments.

The control logic 120 may control the overall operation of the motion sensor 101. The control logic 120 may control the AER unit.

The AER unit may process an event signal output from each of the motion sensor pixels M sensing the change in the quantity of light and may transmit a signal for resetting each motion sensor pixel M that has generated the event signal to the motion sensor pixel M.

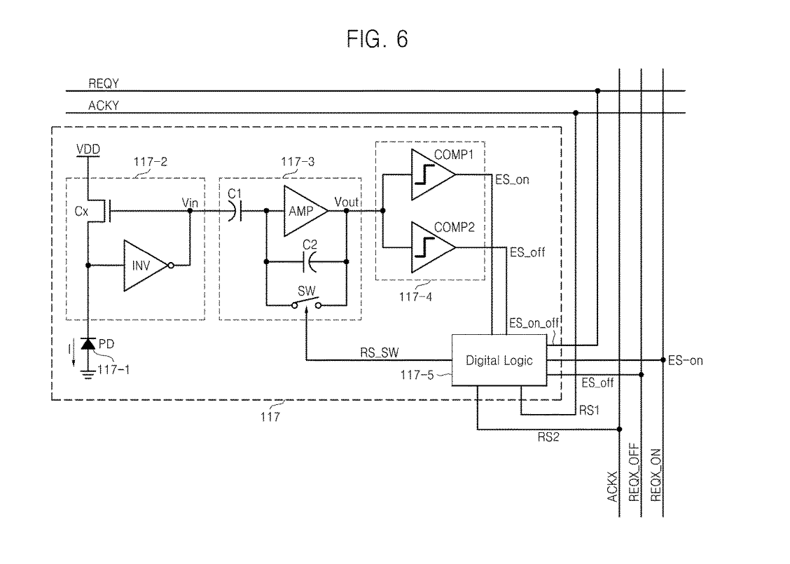

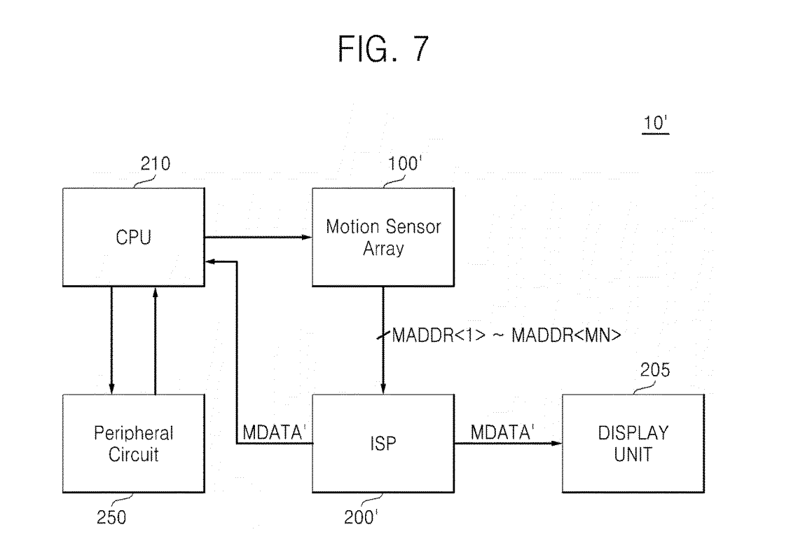

Each motion sensor pixel M in the pixel array 110 may output an event signal according to the change in the quantity of light. The event signal will be described in detail below, with reference to FIGS. 5 and 6. The column AER circuit 140 may receive the event signal and output a column address value CADDR of the motion sensor pixel M, which has generated the event signal, based on the event signal. The row AER circuit 130 may receive the event signal from the motion sensor pixel M and output a row address value RADDR of the motion sensor pixel M, which has generated the event signal, based on the event signal.

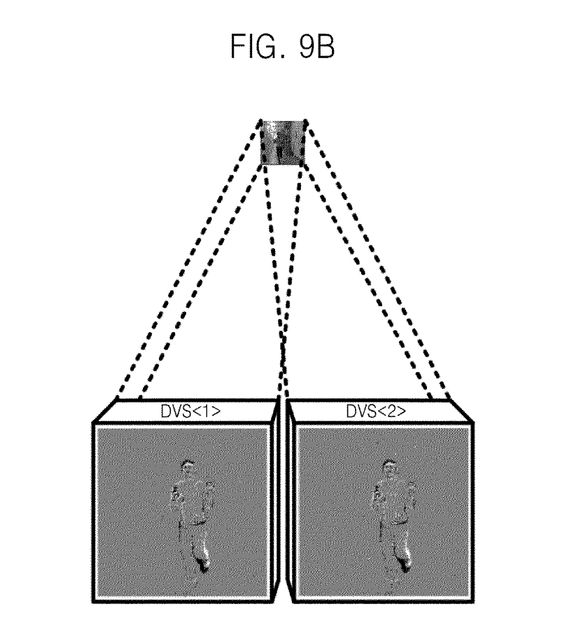

The motion image generator 160 may output motion image data MDATA based on the row address value RADDR generated by the row AER circuit 130 and the column address value CADDR generated by the column AER circuit 140. For instance, the motion image generator 160 may represent a motion sensor pixel M only corresponding to the row address value RADDR and the column address value CADDR in desired (or, alternatively predetermined)color (e.g., black), thereby indicating only pixels having a motion (e.g., pixels having a change of a desired level or higher). The motion image data MDATA may be composed of data representing only pixels having a motion (e.g., pixels having a change of a desired level or higher), as shown in FIGS. 9A and 9B.

When the change in a current of a photodiode occurs due to the change in shade in a motion sensor pixel M, an event signal is generated. For instance, the motion sensor pixel M generates an on-event signal when the current of the photodiode increases and generates an off-event signal when the current decreases.

The motion image generator 160 may detect an event (i.e., on- or off-event) in the motion sensor pixel M from the row address value RADDR generated by the row AER circuit 130 and the column address value CADDR generated by the column AER circuit 140 and may detect whether an object appears in or disappears from the motion sensor pixel M based on the detected event. Accordingly, the motion image generator 160 may detect the moving direction of the object by analyzing over time the output value of every motion sensor pixel M in the pixel array 110, i.e., the row address value RADDR, the column address value CADDR, and the on/off event signal with respect to every motion sensor pixel M. For instance, when an object move from the left to the right in the pixel array 110, the object appears in a motion sensor pixel M, and therefore, an off-event occurs in the motion sensor pixel M. Therefore, pixels having the off-event sequentially appear from the left to the right over time. Accordingly, the motion image generator 160 generates the motion image data MDATA moving from the left to the right over time, and therefore, viewers see the object moving from the left to the right.

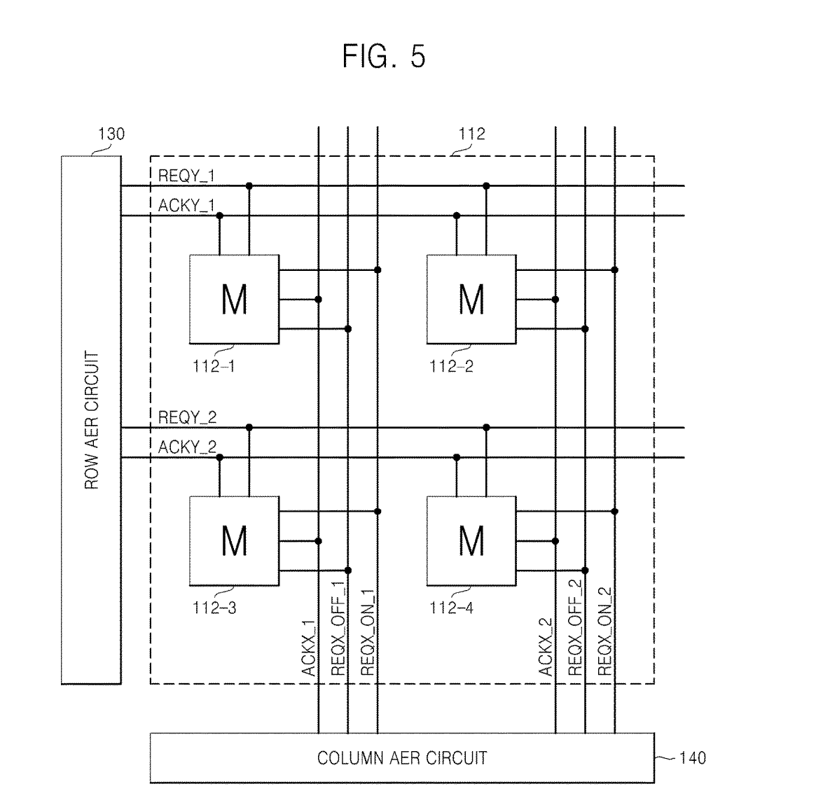

FIG. 4 is a block diagram of the ISP 200 illustrated in FIG. 1, according to an example embodiment of the inventive concepts. The ISP 200 may include a depth sensor (also referred to as “depth information generator”)220 and a three-dimensional (3D) image generator 230. The depth sensor 220 may extract depth information DDATA of the object from the motion image data MDATA<1> through MDATA<MN> generated from respective M×N motion sensors in the motion sensor array 100.

Although the motion sensors sense the motion of the same object, disparity occurs among the motion image data MDATA<1> through MDATA<MN> due to a difference in position (e.g., X and Y coordinates) among the motion sensors. For instance, binocular disparity occurs between two motion sensors and disparity occurs among at least three motion sensors.

The depth sensor 220 may extract the depth information DDATA using disparity among the motion image data MDATA<1> through MDATA<MN>. For instance, the depth sensor 220 may generate the depth information DDATA using an algorithm similar to a method by which human eyes perceive a depth to an object, that is, an algorithm similar to a method of measuring a depth to an object using a difference between binocular disparity angles with respect to the object captured by at least two image sensors. In other words, the depth sensor 220 generates the depth information DDATA from the motion image data MDATA<1> through MDATA<MN>, among which there is disparity, using a principle that a binocular disparity angle is large with respect to an object in a short distance and is small with respect to an object in a long distance. This will be further described below with reference to FIGS. 9A and 9B.

The 3D image generator 230 may generate a 3D image 3D_DATA by combining the depth information DDATA with the motion image data MDATA<1> through MDATA<MN>.

FIG. 5 is a diagram of wiring of the pixel array 110 illustrated in FIG. 3, according to an example embodiment of the inventive concepts. Referring to FIGS. 3 and 5, FIG. 5 shows a part 112 of the pixel array 110, the row AER circuit 130, and the column AER circuit 140. The part 112 of the pixel array 110 includes first through fourth motion sensor pixels 112-1 through 112-4.

In one example embodiment, the first and second motion sensor pixels 112-1 and 112-2 have the same row address and the third and fourth motion sensor pixels 112-3 and 112-4 have the same row address. The first and third motion sensor pixels 112-1 and 112-3 have the same column address and the second and fourth motion sensor pixels 112-2 and 112-4 have the same column address.

Wiring formed in a row direction may include row AER event signal lines REQY_1 and REQY_2 and row AER reset signal lines ACKY_1 and ACKY_2. Each of the motion sensor pixels 112-1 through 112-4 may transmit an on-event signal or off-event signal to the row AER circuit 130 through the row AER event signal line REQY_1 or REQY_2. The row AER circuit 130 may transmit a DVS reset signal to each of the motion sensor pixels 112-1 through 112-4 through the row AER reset signal line ACKY_1 or ACKY_2.

Wiring formed in a column direction may include column AER event on signal lines REQX_ON_1 and REQX_ON_2, column AER off event signal lines REQX_OFF_1 and REQX_OFF_2, and column AER reset signal lines ACKX_1 and ACKX_2. Each of the motion sensor pixels 112-1 through 112-4 may transmit an on-event signal to the column AER circuit 140 through the column AER event on signal line REQX_ON_1 or REQX_ON_2. Each of the motion sensor pixels 112-1 through 112-4 may also transmit an off-event signal to the column AER circuit 140 through the column AER event off signal line REQX_OFF_1 or REQX_OFF_2. The column AER circuit 140 may transmit a DVS reset signal to each of the motion sensor pixels 112-1 through 112-4 through the column AER reset signal line ACKX_1 or ACKX_2.

FIG. 6 is a diagram of one of the motion sensor pixels 112-1 through 112-4 illustrated in FIG. 5, according to an example embodiment of the inventive concepts. Referring to FIGS. 5 and 6, the motion sensor pixels 112-1 through 112-4 illustrated in FIG. 5 may be DVS pixels. The operation of a unit DVS pixel 117 will be described in detail with reference to FIG. 6 when the motion sensor pixels 112-1 through 112-4 are DVS pixels. The unit DVS pixel 117 may include a photodiode (PD) 117-1, a current-to-voltage (I/V) converter 117-2, an amplifier circuit 117-3, a comparator circuit 117-4, and a digital logic 117-5.

The PD 117-1 is an example of a photoelectric conversion element. The PD 117-1 may be any one of, but not limited to, a photo transistor, a photo gate, a pinned photodiode (PPD), and a combination thereof. The PD 117-1 may generate a photocurrent I according to the intensity of incident light.

The I/V converter 117-2 may include a converting transistor Cx and an inverter INV. The converting transistor Cx is connected between a power supply voltage VDD and an end of the PD 117-1. The inverter INV may invert a voltage at the end of the PD 117-1 and output a first voltage Vin. In other words, the I/V converter 117-2 may sense the photocurrent I flowing in the PD 117-1 and output the first voltage Vin corresponding to the photocurrent I.

The amplifier circuit 117-3 may include a first capacitor C1, a second capacitor C2, an amplifier AMP, and a reset switch SW. The amplifier circuit 117-3 may output a second voltage Vout related with a variation of the first voltage Vin over time based on the first voltage Vin. The reset switch SW may reset the second voltage Vout to a reset voltage according to the control of the digital logic 117-5.

The comparator circuit 117-4 may include a first comparator COMP1 and a second comparator COMP2. The first comparator COMP1 may compare the second voltage Vout with an on-threshold voltage and generate an on-event signal ES_on according to the comparison result. The second comparator COMP2 may compare the second voltage Vout with an off-threshold voltage and generate an off-event signal ES_off according to the comparison result.

In other words, the comparator circuit 117-4 may generate the on-event signal ES_on or the off-event signal ES_off when the change of shade in the unit DVS pixel 117 exceeds a desired level (or, alternatively predetermined level), wherein the desired level may be set based on empirical studies and/or user input. For instance, the on-event signal ES_on may be at a high level, when the shade in the unit DVS pixel 117 becomes brighter than the desired level. The off-event signal ES_off may be at a high level, when the shade in the unit DVS pixel 117 becomes darker than the desired level. The on-event signal ES_on and the off-event signal ES_off may be transmitted to the digital logic 117-5.

The digital logic 117-5 may generate an event signal based on the on-event signal ES_on and the off-event signal ES_off received from the comparator circuit 117-4. For instance, the digital logic 117-5 may include an OR element, e.g., an OR gate, and may receive the on-event signal ES_on and the off-event signal ES_off and generate an on/off event signal ES_on_off when the on-event signal ES_on or the off-event signal ES_off is at the high level. The on/off event signal ES_on_off may be transmitted to the row AER circuit 130 through a row AER event signal line REQY. In one example embodiment, the OR gate may be implemented outside the unit DVS pixel 117, for example, within the row AER circuit 130.

The digital logic 117-5 may also transmit the on-event signal ES_on to the column AER circuit 140 through a column AER on event signal line REQX_ON and the off-event signal ES_off to the column AER circuit 140 through a column AER off event signal line REQX_OFF.

In addition, the digital logic 117-5 may generate a reset switch signal RS_SW according to the on-event signal ES_on and the off-event signal ES_off output from the comparator circuit 117-4. For instance, the digital logic 117-5 may include an OR element, e.g., an OR gate, and may receive the on-event signal ES_on and the off-event signal ES_off and generate the reset switch signal RS_SW when the on-event signal ES_on or the off-event signal ES_off is at the high level. The reset switch SW may reset the second voltage Vout in response to the reset switch signal RS_SW. In other embodiments, the OR gate may be implemented outside the unit DVS pixel 117.

In one example embodiment, the OR gate generating the on/off event signal ES_on_off and the OR gate generating the reset switch signal RS_SW may be implemented in one OR gate.

The digital logic 117-5 may receive a first DVS reset signal RS1 through a row AER reset signal line ACKY and a second DVS reset signal RS2 through a column AER reset signal line ACKX. The digital logic 117-5 may generate the reset switch signal RS_SW according to the first DVS reset signal RS1 received from the row AER circuit 130 and the second DVS reset signal RS2 received from the column AER circuit 140.

The digital logic 117-5 may include an AND element, e.g., an AND gate, and may generate the reset switch signal RS_SW when both of the first DVS reset signal RS1 and the second DVS reset signal RS2 are at a high level. In other embodiments, the AND gate may be implemented outside the unit DVS pixel 117.

The unit DVS pixel 117 illustrated in FIG. 6 is just an example and the inventive concept is not restricted to this example. The embodiments of the inventive concept may be applied to any type of pixels that sense the motion of an object.

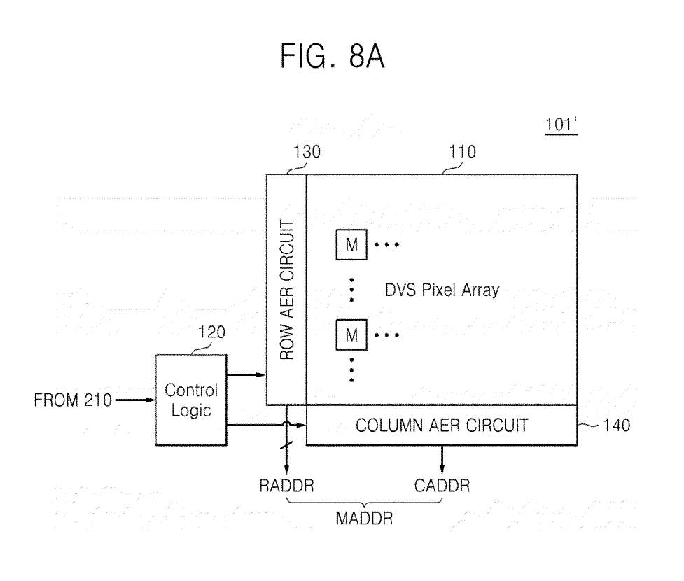

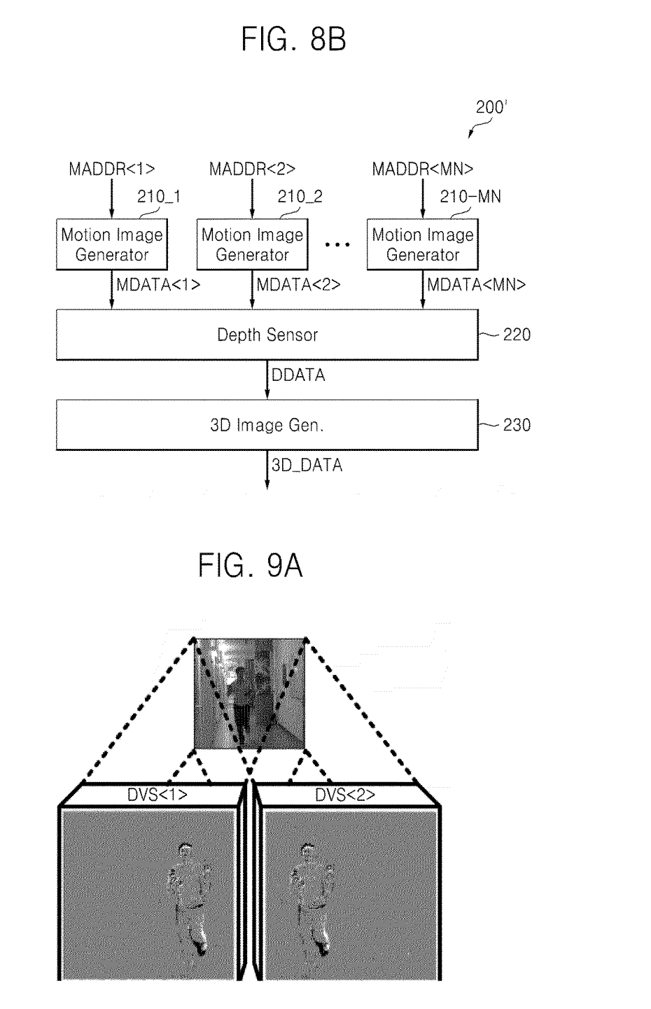

FIG. 7 is a block diagram of a depth sensing system 10′ using a motion sensor array 100′, according to an example embodiment of the inventive concepts. FIG. 8A is a block diagram of a motion sensor 101′, according to an example embodiment of the inventive concepts. FIG. 8B is a block diagram of an ISP 200′, according to an example embodiment of the inventive concepts.

The depth sensing system 10′ illustrated in FIG. 7 is similar to the depth sensing system 10 illustrated in FIG. 1, except as described below.

While the motion sensor array 100 in the depth sensing system 10 illustrated in FIG. 1 outputs the motion image data MDATA<1> through MDATA<MN> respectively generated by M×N motion sensors to the ISP 200, the motion sensor array 100′ in the depth sensing system 10′ illustrated in FIG. 7 outputs motion address information MADDR to the ISP 200′. The motion address information MADDR includes the row address value RADDR generated by the row AER circuit 130 and the column address value CADDR generated by the column AER circuit 140, which have been described above.

While the motion sensor 101 illustrated in FIG. 3 includes the pixel array 110, the control logic 120, the AER unit including the row AER circuit 130 and the column AER circuit 140, and the motion image generator 160,the motion sensor 101′ illustrated in FIG. 8A does not include the motion image generator 160. Instead, motion image generators 210-1 through 210-MN corresponding to the respective M×N motion sensors are included in the ISP 200′, as shown in FIG. 8B.

FIGS. 9A and 9B are diagrams for explaining a depth sensing method using a motion sensor array, according to an example embodiment of the inventive concepts. A motion sensor included in the motion sensor array may sense the motion of an object and generate motion address information corresponding to an address of a potion where the motion has occurred. Motion image data may be generated from the motion address information.

FIGS. 9A and 9B show motion image data captured by two motion sensors DVS<1> and DVS<2>. A depth to an object in FIG. 9A is less than that in FIG. 9B. Disparity between the motion image data respectively captured by the two motion sensors DVS<1> and DVS<2>in FIG. 9A is greater than disparity between the motion image data respectively captured by the two motion sensors DVS<1> and DVS<2> in FIG. 9B. As described above, disparity between motion image data captured by respective motion sensors varies with the depth to an object. Therefore, depth information can be generated from motion image data generated by each motion sensor.

FIG. 10 is a diagram of a motion sensor array device implemented, according to an example embodiment of the inventive concepts. As shown in part (a) in FIG. 10, a plurality of motion sensor arrays may be integrated in a single wafer. Reference numeral 100 denotes a single array including a plurality of motion sensors and a plurality of motion sensor arrays 100 may be integrated in a single wafer.

As shown in part (c) in FIG. 10, the wafer is sawed into individual motion sensor arrays 100 and each of the motion sensor arrays 100 may be implemented in a single chip or package. In other words, a plurality of motion sensors (e.g., DVSs) 101 are grouped into a single motion sensor array 100, as shown in part (b) in FIG. 10, which is implemented in a chip or package. At this time, the motion sensor array 100 is an array of M×N motion sensors 101, where M or N≧2 and M×N may be 2×1 or 1×2. A lens 102 at a wafer level is mounted on each of the motion sensors 101. In other words, a plurality of motion sensors may be implemented on a wafer and a wafer lens may be stacked on each of the motion sensors.

Grouping and packaging a plurality of motion sensors on a wafer into a single motion sensor array as described above simplifies manufacturing processes and reduces manufacturing cost as compared to integrating motion sensors implemented in a chip or package into a motion sensor array. In other embodiments, the motion sensor array device may also include a depth sensor in a single chip or package. In further embodiments, the motion sensor array device may also include a 3D image generator in a single chip or package.

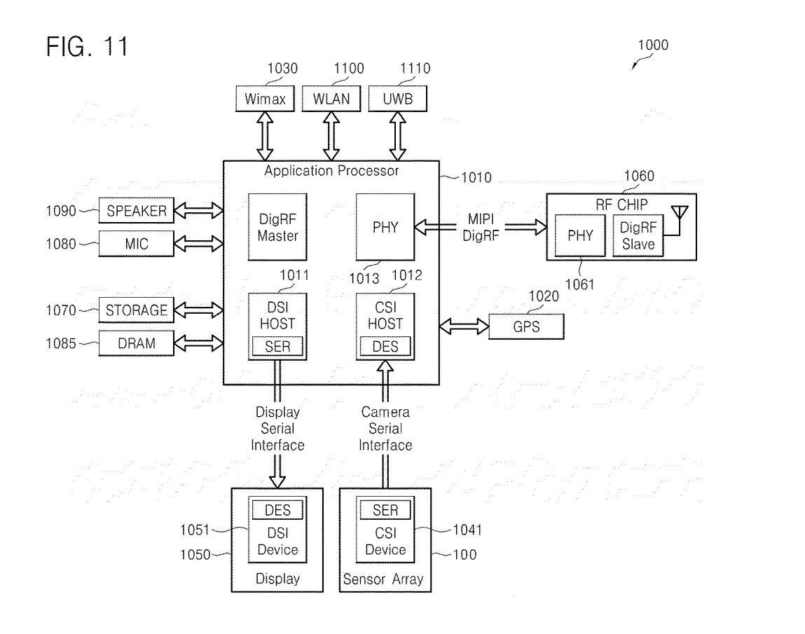

FIG. 11 is a block diagram of an electronic system including the motion sensor array 100 illustrated in FIG. 1, according to an example embodiment of the inventive concepts. Referring to FIGS. 1 and 11,the electronic system 1000 may be implemented by a data processing apparatus, such as a mobile phone, a personal digital assistant (PDA), a portable media player (PMP), an IP TV, or a smart phone that can use or support the MIPI interface. The electronic system 1000 includes the motion sensor array 100, an application processor 1010 and a display 1050.

A CSI host 1012 included in the application processor 1010 performs serial communication with a CSI device 1041 included in the image sensor 1040 through CSI. For example, an optical de-serializer (DES) may be implemented in the CSI host 1012, and an optical serializer (SER) may be implemented in the CSI device 1041.

A DSI host 1011 included in the application processor 1010 performs serial communication with a DSI device 1051 included in the display 1050 through DSI. For example, an optical serializer (SER) may be implemented in the DSI host 1011, and an optical de-serializer (DES) may be implemented in the DSI device 1051.

The electronic system 1000 may also include a radio frequency (RF) chip 1060 which communicates with the application processor 1010. A physical layer (PHY) 1013 of the electronic system 1000 and a PHY of the RF chip 1060 communicate data with each other according to a MIPI DigRF standard. The electronic system 1000 may further include at least one element among a GPS 1020, a storage device 1070, a microphone 1080, a DRAM 1085 and a speaker 1290. The electronic system 1000 may communicate using Wimax 1030, WLAN 1100 or USB 1110, etc.

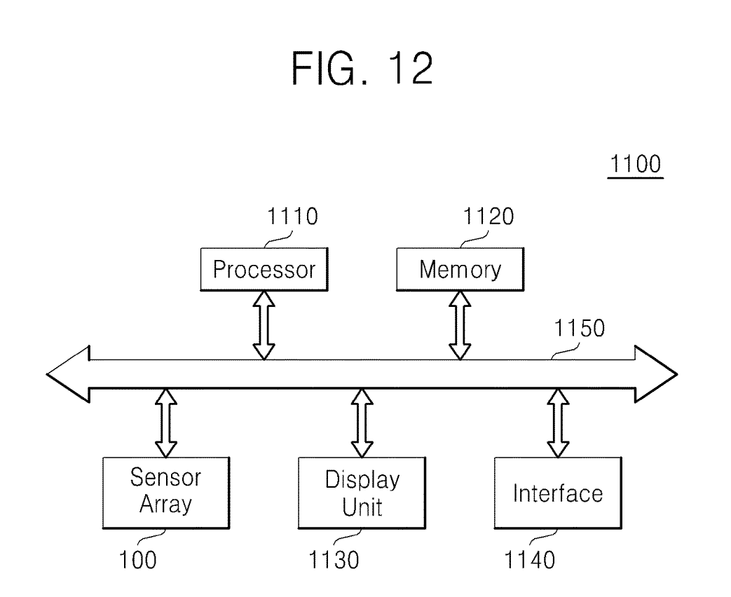

FIG. 12 is a block diagram of an image processing system 1100 including the motion sensor array 100 illustrated in FIG. 1, according to an example embodiment of the inventive concepts. Referring to FIGS. 1 and 12, the image processing system 1100 may include the motion sensor array 100, a processor 1100, a memory 1120, a display unit 1130, and an interface 1140.

The processor 1110 may control the operation of the motion sensor array 100. For instance, the processor 1110 may extract depth information from motion information received from the motion sensor array 100 and generate 3D image data based by combining the depth information and the motion information. The memory 1120 may store a program for controlling the operation of the motion sensor array 100 through a bus 1150 according to the control of the processor 1110 and may store an image generated by the processor 1110. The processor 1110 may access the memory 1120 and execute the program. The memory 1120 may be implemented by non-volatile memory.

The motion sensor array 100 may generate depth information based on a digital pixel signal (e.g., motion information) and may generate 3D image data based on the depth information and the motion information according to the control of the processor 1110.

The display unit 1130 may receive the image from the processor 1110 or the memory 1120 and display the image through a liquid crystal display (LCD) or an active matrix organic light emitting diode (AMOLED). The interface 1140 may be implemented to input and output two- or three-dimensional images. The interface 1140 may be a wireless interface.

As described above, according to example embodiments of the inventive concepts, a motion sensing system obtains depth information from a motion sensor array when necessary, so that the motion sensing system can be implemented with low power as compared to a conventional motion sensing system using a depth sensor that requires a light source.

While the inventive concepts have been particularly shown and described with reference to exemplary embodiments thereof, it will be understood by those of ordinary skill in the art that various changes in forms and details may be made therein without departing from the spirit and scope of the inventive concept as defined by the following claims.

What is claimed is:

1. A motion sensor array device, comprising:
a wafer;
at least two motion sensors implemented on the wafer, each of the at least two motion sensors comprising a plurality of motion sensor pixels configured to sense a motion of an object and generate motion image data; and
at least two lenses respectively arranged on the at least two motion sensors,
wherein the motion sensor array device is implemented in one of a chip and a package.

2. The motion sensor array device of claim 1, further comprising:
a depth sensor configured to extract depth information regarding the object from the motion image data generated by the at least two motion sensors.

3. The motion sensor array device of claim 2, further comprising:
a three-dimensional image generator configured to generate a three-dimensional image by combining the depth information and the motion image data.

4. The motion sensor array device of claim 1, wherein the at least two lenses are wafer lenses, and
the motion sensor array device is implemented in the package.

5. The motion sensor array device of claim 1, wherein each of the motion sensor pixels is a dynamic vision sensor (DVS) pixel.

6. The motion sensor array device of claim 5, wherein each of the at least two motion sensors comprises:
a pixel array comprising a plurality of DVS pixels;
a row address event representation (AER) circuit configured to process at least a first event signal among a plurality of event signals generated by each of the DVS pixels; and
a column AER circuit configured to process at least a second event signal among the plurality of event signals generated by each DVS pixel.

7. A depth sensing system, comprising:
the motion sensor array device of claim 1;
an image signal processor configured to process image data output from the motion sensor array device; and
a central processing unit configured to control the motion sensor array device and the image signal processor.

8. A depth sensing system, comprising:
a motion sensor array comprising at least two motion sensors each of which comprises a plurality of motion sensor pixels configured to sense a motion of an object and generate motion image data; and
a depth sensor configured to extract depth information regarding the object from the motion image data generated by the at least two motion sensors.

9. The depth sensing system of claim 8, wherein the at least two motion sensors comprise:
a first motion sensor configured to sense the motion of the object at a first position and generate first motion image data; and
a second motion sensor configured to sense the motion of the object at a second position and generate second motion image data.

10. The depth sensing system of claim 9, wherein the depth sensor generates the depth information based on disparity between the first motion image data and the second motion image data.

11. The depth sensing system of claim 8, wherein the at least two motion sensors are M×N motion sensors arranged in a matrix form, wherein at least one of M and N is a natural number having a value of at least 2.

12. The depth sensing system of claim 11, wherein the depth sensor generates the depth information based on disparity among motion image data generated by the M×N motion sensors.

13. The depth sensing system of claim 8, wherein the motion sensor array is implemented in one of a chip and a package.

14. The depth sensing system of claim 8, wherein the motion sensor array and the depth sensor are implemented together in one of a chip and a package.

15. The depth sensing system of claim 8, further comprising:
a three-dimensional image generator configured to generate a three-dimensional image by combining the depth information and the motion image data.

16. The depth sensing system of claim 8, further comprising:
at least one lens stacked on each of the at least two motion sensors.

17. A depth sensing method using a motion sensor array, the depth sensing method comprising:
generating motion image data by sensing a motion of an object using at least two motion sensors each of which comprises a plurality of motion sensor pixels; and
generating depth information regarding the object from the motion image data generated by the at least two motion sensors.

18. The depth sensing method of claim 17, wherein the generating the motion image data comprises:
detecting a change in an intensity of light incident on one of the plurality of motion sensor pixels;
generating an event signal based on the detected change;
outputting address information of a motion sensor pixel that generates the event signal; and
generating the motion image data based on the address information.

19. The depth sensing method of claim 17, wherein the generating the depth information comprises:
generating the depth information based on disparity between the motion image data respectively generated by the at least two motion sensors.

20. The depth sensing method of claim 17, further comprising:
generating a three-dimensional image by combining the depth information and the motion image data.

21. A depth sensing system, comprising:
a motion sensor array configured to,
sense motion of at least one object at a plurality of positions, and
generate a plurality of motion image data based on the motion sensed at the plurality of positions; and
an image processor configured to determine depth information of the object based on the plurality of generated motion image data.

22. The depth sensing system of claim 21, wherein the motion sensor array is configured to sense the motion at each of the plurality of positions based on at least one of,
shade information of a frame captured in each of the plurality of positions and at least one stored shade information, and
voltage value of the captured frame and at least one stored voltage value.

23. The depth sensing system of claim 21, wherein the image processor is configured to determine the depth information based on disparity between at least two of the plurality of generated motion image data.

24. The depth sensing system of claim 21, further comprising:
a three-dimensional image generator configured to generate a three-dimensional image by combining the depth information and the plurality of generated motion image data.

25. The depth sensing system of claim 21, wherein the motion sensor array comprises a plurality of motion sensors, each of the plurality of motion sensors sensing the motion at one of the plurality of positions.
